(19) United States
(12) Patent Application Publication
(10) Pub. No.: US 2008/0202415 A1
(43) Pub. Date: Aug. 28, 2008

(54) Methods and systems for addition of cellulose ether to gypsum slurry

(76) Inventors: David Paul Miller, Lindenhurst, IL (US); Qingxia Liu, Vernon Hills, IL (US); Qiang Yu, Grayslake, IL (US)

Correspondence Address: GREER, BURNS & CRAIN, LTD., 300 SOUTH WACKER DRIVE, SUITE 2500, CHICAGO, IL, 60603, US

(21) Appl. No.: 11/713,951

(22) Filed: Feb. 28, 2007

(51) Int. Cl. B05C 1/14

(52) U.S. Cl. 118/708

(57) ABSTRACT

An example system for making a gypsum board product comprises a container for containing a gypsum slurry, a moving receiver in communication with the container, wherein the container substantially continuously deposits the gypsum slurry on the moving receiver. A first and at least a second cellulose ether supply containing a first cellulose ether communicate with the container. The first and second supplies contain cellulose ethers having different physical or chemical properties. A controller is configured to change the amount of the first and second cellulose ethers delivered to the container in response to a change in at least one slurry physical property.

### FIELD OF THE INVENTION

A field of the invention is methods and systems for making gypsum board products. An additional field of the invention is methods and systems for addition of cellulose ether to gypsum slurry.

### BACKGROUND

This invention relates to improved gypsum products and methods for making them. Example embodiments include methods and systems for addition of cellulose ether to a gypsum slurry that is useful to make gypsum board products such as gypsum wallboard, gypsum fiberboard, and the like (use of the term “gypsum board” herein is intended to include at least both of gypsum fiberboard and gypsum wallboard products).

Gypsum board products are commonly used as building materials, with an example being wallboard and fiberboard sheets, for many reasons. They are easily manipulated to make continuous walls of desired shapes and sizes. They are durable, easily patched and have beneficial fire and sound proofing properties. Decorative finishes, such as wallpaper or paint readily adhere to surfaces to allow for a large variety of decorating options.

Gypsum wallboard sheets can be made by adding water to calcined gypsum, also known as calcium sulfate hemihydrate, to form a pumpable and flowable slurry. The resulting slurry is continuously deposited between two sheets of wallboard facing material or wallpaper running at high speed. As the slurry sets, or converts from the hemihydrate to the dihydrate form, the calcined gypsum absorbs water from the slurry to form an interlocking matrix of calcium sulfate dihydrate crystals between the wallboard sheets. Excess water evaporates or is driven off by drying or other means, leaving voids in the matrix once occupied by the water. Foam may also be added to the slurry to introduce gaseous bubbles which are ultimately captured within the crystalline gypsum dihydrate. These can be beneficial to reduce the density of the final products without a significant reduction in strength.

Gypsum wallboard is typically made on high speed continuous lines. The slurry must be prepared, deposited between the wallboard sheets, corners shaped and dried in very brief time periods that can be, for example, only a few minutes. After this time period, the final board must be relatively stable. The physical properties of the slurry are relatively tightly controlled in order to achieve satisfactory performance of this high speed, continuous process.

Gypsum fiberboard sheets can be made by combining gypsum in its dihydrate form with cellulosic fibers such as wood or paper pulp. Water is added to form a slurry. The slurry is heated, typically under pressure, to calcine the gypsum and convert it to its hemihydrate form. Hemihydrate crystals form around and on the cellulosic fibers. The slurry is then deposited under atmospheric conditions on a forming wire. As water is removed on the forming wire and the slurry cools, the hemihydrate rehydrates to form an interlocking solid matrix of crystals about the cellulosic fibers.

Proposals have been made to increase the strength of gypsum board products or otherwise affect their properties. Some proposals include providing one or more additives to the gypsum slurry to affect the characteristics of the resulting dried product. Some proposed additives, however, may adversely affect the viscosity or other properties of the slurry. Such incompatibility effects can result in reduced final product strength, lowered manufacturing efficiencies and/or increased manufacturing cost.

Taking the slurry viscosity with wallboard products as an example, too high of a viscosity can complicate the tasks of effectively mixing the slurry and evenly spreading the fast setting slurry between the fast moving wallboard sheets. In the case of fiberboard, too high of a viscosity and/or excess tackiness can result in the fiberboard “sticking” to the forming wire or other process equipment and resultant damage to the final board product.

Empirical testing and predictive modeling can be used to predict changes in manufacturing process chemistry that will result upon addition of one or more additives to the slurry. The large number of process variables, with examples including different types of dry calcined gypsum, multiple potential combinations of different additives in different concentrations, temperature variations, and the like, make such predictive modeling and empirical testing impractical in some applications.

Accordingly, problems exist in the art related to effective addition of additives to gypsum slurries.

### SUMMARY OF THE INVENTION

The present invention addresses the above outlined and other problems in the art.

An example system for making a gypsum board product comprises a container for containing a gypsum slurry and a moving receiver receiving gypsum slurry deposited by the container. A first and at least a second cellulose ether supply containing a first cellulose ether communicate with the container. The first and second supplies contain cellulose ethers having different physical or chemical properties. A controller is configured to change the amount of the first and second cellulose ethers delivered to the container in response to a change in at least one slurry physical property.

### BRIEF DESCRIPTION OF THE DRAWINGS

FIG. 1A is a schematic useful to illustrate a first example method and system of the invention;

FIG. 1B is a schematic showing an alternate configuration of a portion of the system of FIG. 1A;

FIG. 2 is a schematic useful to illustrate a second example method and system of the invention;

FIG. 3 is a schematic useful to illustrate a third example method and system of the invention; and,

FIG. 4 is a schematic useful to illustrate a fourth example method and system of the invention.

### DETAILED DESCRIPTION OF THE INVENTION

Before discussing example embodiments of the invention in detail, it will be appreciated that the present invention may be practiced in the form of a system and/or as a method. It will further be appreciated that in describing a system of the invention, description of a method of the invention may be simultaneously made. For example, a method of the invention may include steps of using or operating a system of the invention.

It has been discovered that cellulose ether can improve the performance of some gypsum products. Taking gypsum fiberboards as an example, it has been discovered that addition of cellulose ether to the gypsum slurry used to form the gypsum fiberboard can result in increased strength of the final fiberboard product. These beneficial results are likewise believed to result from use of cellulose ethers with gypsum wallboard products. It is believed that the increase in strength is at least partially a result of the cellulose ether increasing chemical and/or mechanical bonds within the board products.

For example, it is believed that the cellulose ether forms a flexible polymer webbing and/or film interspersed with the calcium sulfate dihydrate solid in the final board product, and that this film is useful to distribute loads bearing on the solid. The film and other effects of the cellulose ether may be useful to strengthen gypsum-to-gypsum bonding, gypsum-to-wallboard facing-sheet bonding (in wallboard), and gypsum to cellulosic fiber bonding (in fiberboard). This and other effects of cellulose ether additives lead to increased flexural strength of the wallboard product without any significant increase in board thickness or appreciable change in density.

Any of several cellulose ethers are believed to be useful in practice of systems and methods of the invention. Cellulose ethers include a large number of cellulose derivatives, and may be obtained by reacting cellulose with an alcohol. Cellulose is the chief constituent of the cell walls of plants. Chemically, it is a carbohydrate that is a high molecular weight polysaccharide. An ether is any of a number of organic compounds whose molecules contain two hydrocarbon groups joined by single bonds to an oxygen atom.

Cellulose ethers are long-chain polymers. Their solution characteristics depend on the average chain length or degree of polymerization (DP) as well as the degree of substitution (DS). Average chain length and degree of substitution determine molecular weight of the polymer. As molecular weight increases, the viscosity of cellulose ether solutions increases rapidly. Some commercially available cellulose ethers have MW's that vary from about 90,000 (DP=400) to 700,000 (DP=3,200). Particular examples of cellulose ethers believed to be useful with methods and systems of the invention include, but are not limited to, ethyl celluloses, propyl celluloses such as hydroxypropyl cellulose, and methyl celluloses. Readily available commercial examples including CULMINAL MC 7000 methyl cellulose and CULMINAL HPMC 1034 methyl hydroxypropyl cellulose from HERCULES AQAULON Division, Wilmington, Del. Others include cellulose ether products from DOW CHEMICAL, Midland, Mich., including methyl celluloses such as A4C, A15, A40 and others, and DOW's hydroxypropyl methylcellulose products.

Due to the effects of branching, chain length, etc., the viscosity of methyl celluloses are typically described based on the Brookfield viscosity of a 2% solution at 68° F. (20° C.) using a RV viscometer at 20 rpm. For the CULMINAL HPMC, typical viscosity is about 30,000 with a dry particle size of 8% max on a No. 120 (0.125 mm) screen. A range is between about 20-50,000 cps. For the CULMINAL MC, a range is between about 10-15,000 cps. In many applications of the invention, ranges between about 5,000-50,000 and between about 1,500-15,000 for the HPMC and MC, respectively, will be useful. Other suitable ranges are 10,000-50,000 and 3,000 to 15,000 for the HPMC and MC, respectively.

When dissolved in cold water, cellulose ethers initially dissolve and then hydrate to form a viscous solution or gel. Viscosity generally varies with MW-longer chain (higher MW) cellulose ethers result in higher viscosity gels or solutions. Cellulose ether is not soluble in hot water. The temperature at which cellulose ether begins to dissolve in water depends at least to some extent on chain length (MW). For many cellulose ethers in water, solubility changes at temperatures of about 150°-160° F. (about 66°-82° C.) (and above about 180° F. [82° C.] for hydroxyl propyl cellulose ether). Cellulose ether is generally not soluble in aqueous solutions above this temperature and generally is soluble below it. In hot water (e.g., above about 180° F.) it is a suspension, in cold water (e.g., below about 150° F.) before it thickens, it is a solution. Once it hydrates, it forms a gel.

### FIRST EXAMPLE SYSTEM AND METHOD

Having now discussed some physical properties and characteristics of some cellulose ethers that may be useful in practice of invention embodiments, further detail regarding methods and systems that exploit these properties or result in improved gypsum board products can be discussed.

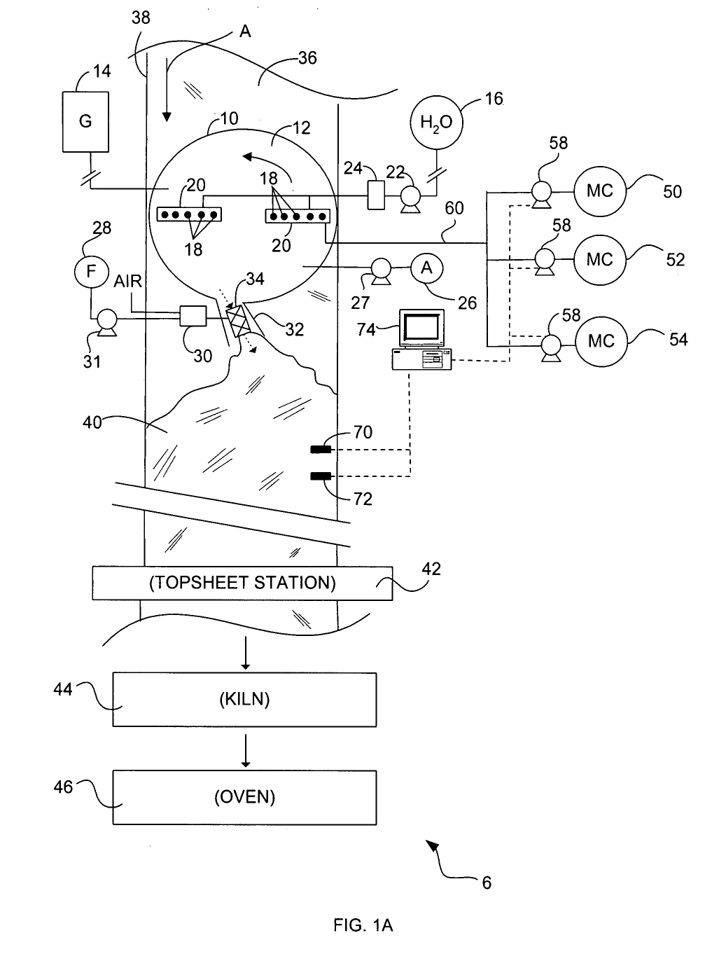

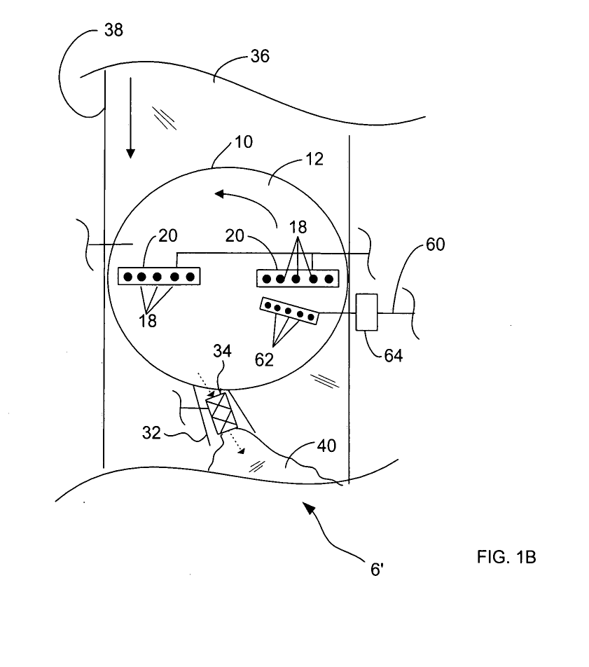

FIG. 1A schematically illustrates one example system for continuously making a gypsum wallboard product. While individual gypsum panels can be made in a batch process, continuous processes that form gypsum board into a long panel which is cut into panels of desired lengths generally offer efficiency and commercial advantages.

Referring to the schematic of FIG. 1A by way of further illustration, a container such as a rotating pin mixer 10 is provided for mixing the solid and liquid components of the slurry in any order. The mixer 10 includes a mixing chamber 12. Rotating pin mixers are generally known in the art, and detail herein is therefore not provided for the sake of brevity. Briefly, rotating pin mixers generally include pins extending upward in the mixing chamber, and a plurality of downwardly extending pins from an overhead member that rotate relative to the upward extending pins. The rotation of the pins causes a circular motion and mixing of the fluid contained in the mixing chamber. Interaction between the circulating fluid and the stationary pins enhances mixing.

Dry components of the slurry, including a calcined gypsum or stucco and any dry additives, are preferably blended together prior to delivery to the mixer 10. The dry components are added to the liquid water in the mixing chamber 10, and blended until the dry components are moistened. In the schematic of FIG. 1A, solid calcined gypsum is continuously delivered to the mixer chamber 12 from calcined gypsum supply 14. Supply 14 can be a tank, bin, or the like. The delivery from supply 14 may be through conveyer or similar means. For example, a conduit may be provided in a non-rotating portion of the mixer 10 through which a continuous supply of calcined gypsum is delivered through a conveyer. A metering device can be provided (not shown) at the supply 14 or another location to monitor and control the amount of gypsum supplied. It may be desirable to deposit the gypsum in the mixing chamber 12 over a dispersed area to facilitate mixing.

Water is delivered from water supply 16 to the mixer 10. A plurality of nozzles 18 may be mounted on a rack 20 on or within the mixing chamber 12 for dispersing the delivered water over a relatively larger area of the mixing chamber 12 diameter. A plurality of supports or racks 20 each containing a plurality of nozzles 18 may be provided, with an example being the two racks 20 shown in FIG. 1A. One or more pumps 22 may be provided to supply the water, as well as one or more heat exchangers 24 to heat (or chill) the water. One or more measuring devices may be provided to control the amount of water delivered to the mixer 10. The measuring device may be, for example, a valve (not illustrated), a metering pump (such as pump 22), the nozzles 18, other devices, or combinations of these. A heat and mass balance is desirably maintained on the mixer 10 to control the physical properties of the slurry being prepared.

Any amount of water may be used to make the gypsum slurry as long as the slurry has sufficient fluidity for the application being considered. The amount of water varies depending on factors including the source of the gypsum, how it is calcined, the additives and the product being made. For many wallboard applications, a water to gypsum ratio (weight) of about 0.18 to about 0.8 is often used, or from about 0.4 to about 0.8. Excessive water may be removed from the resulting slurry using downstream driers, but such removal adds energy costs and is therefore to be avoided when possible.

The slurry will typically have a high viscosity (that of, by way of example, a heavy oil or molasses) and be relatively fast setting. Slurry residence time in the mixing chamber 12 will vary, but in many applications the residence time is less than 30 seconds and may be only a fraction of al second. In this short time, a substantially homogeneous slurry is desirably prepared. To achieve efficient mixing of this thick and fast setting slurry, the mixer 10 may utilize high RPM's, with an example being about 250 to about 350.

Some embodiments of the invention also provide for addition of one or more solid or liquid additives to the slurry from additive supply 26. Additives may be useful to modify one or more properties of the final wallboard product. A pump 27 or like device may be provided to deliver the additive from supply 26, and also to meter it into a desired amount. Additives are used in the manner and amounts as are known in the art. Concentrations are reported in amounts per 1000 square feet of finished board panels (“MSF”). Starches can be used in amounts up to about 20 lbs./MSF (14.6 to 97.6 g/m²) to increase the density and strengthen the product. Glass fibers are optionally added to the slurry in amounts up to about 11 lb./MSF (54 g/m²). Up to 15 lb./MSF (73.2 g/m²) of paper fibers can also be added to the slurry. Wax emulsions or other water resistance additives can be added to the gypsum slurry in amounts up to 90 lbs./MSF (0.4 kg/m²) to improve the water-resistency of the finished gypsum board panel.

Set retarders (up to about 2 lb./MSF (9.8 g/m²)) or dry accelerators (up to about 35 lb./MSF (170 g/m²)) can be added to modify the rate at which the hydration reactions take place. “CSA” is a set accelerator comprising 95% calcium sulfate dihydrate co-ground with 5% sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 1000 pounds of calcium sulfate dihydrate. It is further described in U.S. Pat. No. 2,078,199, herein incorporated by reference. Both of these are preferred accelerators.

Another accelerator, known as wet gypsum accelerator or WGA, is also a preferred accelerator. A description of the use of and a method for making wet gypsum accelerator are disclosed in U.S. Pat. No. 6,409,825, herein incorporated by reference. This accelerator includes at least one additive selected from the group consisting of an organic phosphonic compound, a phosphate-containing compound or mixtures thereof. This particular accelerator exhibits substantial longevity and maintains its effectiveness over time such that the wet gypsum accelerator can be made, stored, and even transported over long distances prior to use. The wet gypsum accelerator is used in amounts ranging from about 5 to about 80 pounds per thousand square feet (24.3 to 390 g/m²) of board product.

Other potential additives to the wallboard are biocides to reduce growth of mold, mildew or fungi. Depending on the biocide selected and the intended use for the wallboard, the biocide can be added to the covering, the gypsum core or both. Examples of biocides include boric acid, pyrithione salts and copper salts. Biocides can be added to either the facing or the gypsum core. When used, biocides are used in the facings in amounts of less than about 500 ppm.

In addition, the gypsum composition optionally can include a starch, such as a pregelatinized starch and/or an acid-modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). One of ordinary skill in the art will appreciate methods of pregelatinizing raw starch, such as, for example, cooking raw starch in water at temperatures of at least about 185° F (85° C.) or other methods.

Suitable examples of pregelatinized starch include, but are not limited to, PCF 1000 starch, commercially available from Lauhoff Grain Company and AMERIKOR 818 and HQM PREGEL starches, both commercially available from Archer Daniels Midland Company. If included, the pregelatinized starch is present in any suitable amount. For example, if included, the pregelatinized starch can be added to the mixture used to form the set gypsum composition such that it is present in an amount of from about 0.5% to about 10% percent by weight of the set gypsum composition. Starches such as USG95 (United States Gypsum Company, Chicago, Ill.) are also optionally added for core strength.

Other known additives may be used as needed to modify specific properties of the product. Sugars, such as dextrose, are used to improve the paper bond at the ends of the boards. Wax emulsions or polysiloxanes are used for water resistance. If stiffness is needed, boric acid is commonly added. Fire performance can be improved by the addition of vermiculite. These and other known additives are useful in the present systems and methods for preparing gypsum slurries.

The example system 6 further provides for introduction of a foaming agent to the slurry. Foams are useful to control the density of the resultant wallboard core material. Many foaming agents are well known and readily available commercially, with examples including those from GEO Specialty Chemicals, Ambler, Pa. Such an aqueous foam is usually generated by high shear mixing of an appropriate foaming agent together with water from supply 28 with air in a foam mixing chamber schematically shown at element 30 that may be closely adjacent to the location for introducing the foam into the slurry. The amount and quality of foam delivered may be controlled through use of valves (not illustrated), pump 31, and like devices to control the quantity of surfactant from supply 28, air supplied, and the like.

The foam can be inserted into the slurry as it exits the mixing chamber 12 through a discharge conduit 32. See, for example, U.S. Pat. No. 5,683,635, herein incorporated by reference. By way of further example, a static mixer, which has been schematically shown as element 34 in FIG. 1A, may be provided within the conduit 32 for ensuring good mixing of the foam into the slurry. Static mixers such as the mixer 34 are known in the art, and generally include a plurality of stationary baffles or trays that are arranged with one another such that one or more fluids flowing past can be mixed with one another.

The slurry is continuously dispensed through the one or more conduits 32 from the mixing chamber 12 and deposited onto a moving wallboard facing material 36 being carried on a moving receiver such as a high speed conveyer 38 in the direction shown by arrow A in FIG. 1A. In the schematic of FIG. 1A the deposited slurry has been identified as element number 40. The discharge conduit 32 may have a wider exit than entrance to encourage spreading of the slurry 40 and decrease velocity out of the mixing chamber 12 and onto the wallboard facing material 36.

Wallboard facing materials are well known to those knowledgeable in the art. Multi-ply paper is one example facing material, with other examples including single-ply paper, cardboard, polymers, non-wovens, plastic sheeting and the like. Another paper cover sheet is optionally placed on top of the slurry at station 42 downstream of the mixer 10, so that the slurry 40 is sandwiched between two moving cover sheets which become the facings of the resultant gypsum panel.

The thickness of the resultant board is controlled by a forming plate (not illustrate), and the edges of the board are formed by appropriate mechanical devices (not shown) which continuously score, fold and glue the overlapping edges of the paper. While the shape of the slurry 40 is maintained, the calcined gypsum is kept under conditions sufficient (which can be, for example, temperature of less than about 120° F.) to react with a portion of the water to set and form an interlocking matrix of gypsum crystals.

The thus formed gypsum wallboard material may be subjected to drying downstream of the station 42 to remove excess water. A two-stage drying process may be used. A first stage may include about 20-50 mins. in a high temperature kiln (schematically shown at 44) operating at air temperatures of about 300° F. or more to rapidly remove excess water. A second stage can include an oven (schematically shown at 46) operating at a lower temperature configured to limit overdrying and calcination of the board.

Referring once again to the initial preparation of the gypsum slurry, the example system 6 includes a plurality of cellulose ether supplies 50-54 in communication with the slurry mixer 10. Although three cellulose ether supplies 50-54 are provided in the example system 6, other numbers are contemplated with examples being two, four, or more. Each contains a cellulose ether having different physical properties. As used herein the term “cellulose ether” is intended to be broadly interpreted as referring to an aqueous solution, gel, suspension that contains a cellulose ether (including but not limited to the cellulose ethers identified above) in liquid or solid form. Further, the term is intended to include materials that include other active ingredients in addition to a cellulose ether.

Each supply 50-54 may contain, for example a cellulose ether containing different cellulose ethers having a different MW, DS, and/or viscosity from others of the supplies 50-54. Although the cellulose ethers stored in the supplies 50-54 may be solid or liquid, they are contemplated to be in liquid form in the example system of FIG. 1. They may comprise, for example, aqueous solutions, suspensions or gels of cellulose ether.

Each of the supplies 50-56 communicates with the slurry mixer 10. It will be appreciated that as used herein, the term “communicates” when used in this context does not require direct communication, but may include communication through an intermediary, with examples including the water nozzles 18 or the gypsum supply 14. A metering pump 58 is connected to each of the supplies 50-56 and is configured to deliver a desired amount of cellulose ether from the respective supply 50-54 to the mixer 10 through a common conduit or pipeline 60. Other example systems may use separate pipelines 60, with one each dedicated to one each of the supplies.

In the example system 6 of FIG. 1, the common pipeline 60 delivers cellulose ether from one or more of the supplies 50-54 to the slurry mixer 10 through one or more of the water delivery nozzles 18. A sufficient number of nozzles 18 can be utilized to achieve good distribution of the cellulose ether in the slurry mixer 10. A mixing chamber (not illustrated) upstream of the nozzles 18 having a static mixer to ensure good mixing of the cellulose ether with the water may also be provided.

In addition to delivery of the cellulose ether via the nozzles 18, other locations and delivery means are contemplated. FIG. 1 B is a schematic showing only a portion of a system 6′ which is one example alternate configuration of the system 6 for delivering the cellulose ether to the mixing chamber 12. In the example of FIG. 1B, an additional set of nozzles 62 have been provided in communication with the pipeline 60 for delivering the cellulose ether to the mixing chamber 12. The nozzles 62 could be used to spray or otherwise disperse the cellulose ether over a relatively wide portion of the radius or diameter of the mixing chamber 12.

The nozzles 62 thereby provided a means for dedicated delivery of the cellulose ether separate from the water delivered through nozzles 18. A heat exchanger 64 can be provided in communication with the pipeline 60 for heating the cellulose ether delivered through the nozzles 62 to a desired temperature for purposes, for example, of affecting the material viscosity.

Regardless of method of delivery, as discussed above addition of cellulose ether to the gypsum slurry is believed to provide useful benefits and advantages to the final wallboard product, including increased flexural board strength. Differing amounts of cellulose ether may be useful depending on factors such as slurry water content, additives present, properties of the dry gypsum present, the MW, chain length and DS of the cellulose ether, and the like. In many applications, it is believed that a range of about 0.3-2% by weight cellulose ether on a dry weight basis of calcined gypsum is useful.

Generally, longer chain and higher MW cellulose ether is believed to provide greater strength enhancement than is lower MW and shorter chain cellulose ether. Longer chain and higher MW cellulose ether, however, tend to cause a greater increase in the viscosity of the gypsum slurry than do shorter chain and lower MW cellulose ether. Accordingly, there is a risk that introducing longer chain and higher MW cellulose ether may lead to unacceptably high gypsum slurry viscosity.

It may be possible to empirically predict a precise chain length and MW cellulose ether, as well as a precise amount thereof, to deliver to the gypsum slurry while remaining within an acceptable viscosity range. It has been discovered, however, that the numerous process variables in some real-world gypsum board manufacturing processes make such a prediction difficult and/or impractical.

Constantly changing process variables such as ambient temperature, atmospheric pressure, and humidity, for example, can affect slurry viscosity and other physical properties. Compatibility issues may arise between the cellulose ether and one or more of the numerous different additives that may be introduced to the gypsum slurry in differing amounts. Some compatibility issues may affect slurry viscosity. The speed of the mixer, pressure and temperature of the water emitted from the nozzles, and other variables may also affect the slurry physical properties. Predicting what MW and chain length cellulose ether, and in what amount, should be provided to the slurry to avoid exceeding a viscosity limit under the constantly changing environment that includes this large matrix of variables is not practical.

It has been discovered, however, that these and related problems can be addressed by providing regular or substantially continuous measurements of the physical properties of the slurry 40, with an example being its viscosity (or any physical property that is related to or can be used to estimate viscosity, with examples being temperature, pH and foam content) and using this data to make running changes to the quantity or quality of cellulose ether being delivered to the slurry mixer 10. Through methods and systems of the invention, these real-time measurements can be exploited to determine an effective quantity and/or quality of cellulose ether to provide to the slurry mixer 10. This may be further illustrated through the following illustration of various features of example systems of the invention.

Referring once again to the example system 6 of FIG. 1A by way of example, first and second sensors 70 and 72 are provided and positioned downstream of the slurry mixer 10. The sensors 70 and 72 are configured to measure one or more physical properties of the slurry 40, with example properties including pH, foam content, temperature and viscosity. For example, the sensor 70 may measure temperature and the sensor 72 may measure foam content and pH. Or, both sensors 70-72 may measure the same property(s) to provide a greater degree of reliability.

A wide variety of sensors 70-72 may be used with systems of the invention. Examples range from relatively simple thermocouples to sophisticated electronic testing devices. In some invention embodiments the sensors 70-72 are configured to provide substantially continuous measurement data, while in other example embodiments measurement data may be provided on an intermittent basis (e.g., every 30 sec., every min., every 90 sec., etc.).

In many wallboard invention embodiments, at least one of the sensors 70 is configured to measure slurry 40 temperature data, one to measure pH, and/or one to measure foam content. In other wallboard applications viscosity may also be measured, but the relatively high viscosity slurry and in-line application can make such measurement difficult.

Each of the sensors 70-72 are electrically linked to a controller 74. The controller 74 may be, for example, a computer such as a desktop or laptop PC, a server, a networked computer device, handheld processor based device, dedicated processor based controller, or other processor based device. The controller 74 may also be combined or integral with some other device, with an example being a sensor 70 or 72 or metering pump 58. Although only one controller 74 is illustrated in FIG. 1, other numbers may be provided. The controller 74 may include a memory with one or more software programs for operating each of the sensors 70-72, and for processing data from the sensors, with examples being temperature and/or viscosity data. The controller 74 may further include a user interface for user control, and may be linked to a network or with other computers for remote control and other remote interactive capabilities.

The controller 74 is additionally electrically linked to each of the metering pumps 58, and is configured to control the amount of cellulose ether delivered from each of the supplies 50-56. In this manner, the example system 6 can provide beneficial real-time feedback and control of the addition of cellulose ether, and can dynamically vary the amount and/or composition of the cellulose ether added to react to changing properties of the slurry 40. Properties such as the viscosity of the deposited slurry 40 can thereby be maintained in a desired range without the need for stopping the continuous manufacture process.

For example, the controller 74 can respond to a measured increase in slurry 40 viscosity by causing less cellulose ether to be delivered to the slurry mixer 10, and/or by causing a lower viscosity cellulose ether to be delivered. Likewise, if the sensors 70 or 72 indicate that the viscosity is below an allowable maximum, the controller 74 can respond by delivering an increased quantity of cellulose ether and/or a higher viscosity cellulose ether to the mixer 10.

This can be further illustrated by the following example. Assume that the supplies 50-56 contain four different cellulose ethers —a “high” viscosity methyl cellulose (MW over 200,000) in supply 50, a “medium” viscosity methyl cellulose material (MW about 125,000-175,000) in supply 52, and a “low” viscosity methyl cellulose material (MW less than 100,000) in supply 54. One supply, for example, may contain a cellulose ether such as the CULMINAL HPMC, and a second the CULMINAL MC. Assume that the controller 74 initially controls the metering pumps 58 to cause only medium viscosity cellulose ether to be delivered to the slurry mixer 10.

A minimum and maximum viscosity for the slurry may be set. If one or both of the sensors 70-72 subsequently indicates that the viscosity of the deposited slurry 40 has exceeded the pre-set maximum, or has exceeded some allowable rate of increase (e.g., increased 10% in 3 minutes), the controller 74 can operate the metering pumps 58 to lower the slurry viscosity. This may be accomplished through any of several alternative steps. In one example, the controller 74 can cause the metering pumps 58 to deliver a smaller overall quantity of methyl cellulose material to the slurry mixer 10. Doing so, however, may reduce (but not eliminate) the benefits of the methyl cellulose in the final wallboard product.

In another example, the controller 74 can manipulate the metering pumps 58 to maintain substantially the same quantity of methyl cellulose material being delivered to the slurry mixer 10, but to cause an overall lower viscosity mixture to be delivered. For example, the controller can manipulate the pumps 58 so that only “low” viscosity methyl cellulose from supply 54 is delivered to the mixer 10 until a control parameter such as temperature or pH changes to indicate that a higher viscosity methyl cellulose can be used. The controller 74 could also manipulate the pumps 58 so that a desired mixture of “low” and “medium” viscosity methyl cellulose from supplies 52 and 54 was delivered that had an overall lower viscosity than only “medium” viscosity methyl cellulose. Examples include causing the pumps 58 to deliver a 1:1, 2:1, 3:1 or other appropriate ratio of “medium” to “low” viscosity methyl cellulose to the slurry mixer 10.

The controller 74 with feedback from sensors 70 and 72 may utilize a proportional-integral-derivative (PID) loop control logic or the like to maintain the addition of methyl cellulose to result in the slurry 40 viscosity being at a set point or within a desired range:

Viscosity_{MIN}≦Viscosity_{slurry}≦Viscosity_{MAX}

It will be appreciated that viscosity may be determined or approximated using one or more of temperature, pH or foam content, so that the above relation is equivalent to maintaining balances of these properties.

The controller 74 may additionally build a history in a memory of past performance of amounts and ratios of supplies 50-54 supplied verses resultant slurry 40 viscosity. This history can be used to tune the PID control equation (e.g., adjust gain), and/or to otherwise build predictive models to achieve more efficient cellulose ether addition control over time.

The example system 10, including the sensors 70-72, the controller 74, and the metering pumps 58 can thereby be used to continuously monitor the physical properties of the deposited slurry 40, and dynamically adjust the quantity and quality of cellulose ether being delivered to the slurry mixer 10 to maintain desirable physical properties of the slurry 40. This provides valuable advantages and benefits, with an example being an ability to dynamically and continuously respond to changing process parameters without the need for advance empirical testing or modeling, and without the need to interrupt the continuous wallboard manufacture process.

### SECOND EXAMPLE SYSTEM

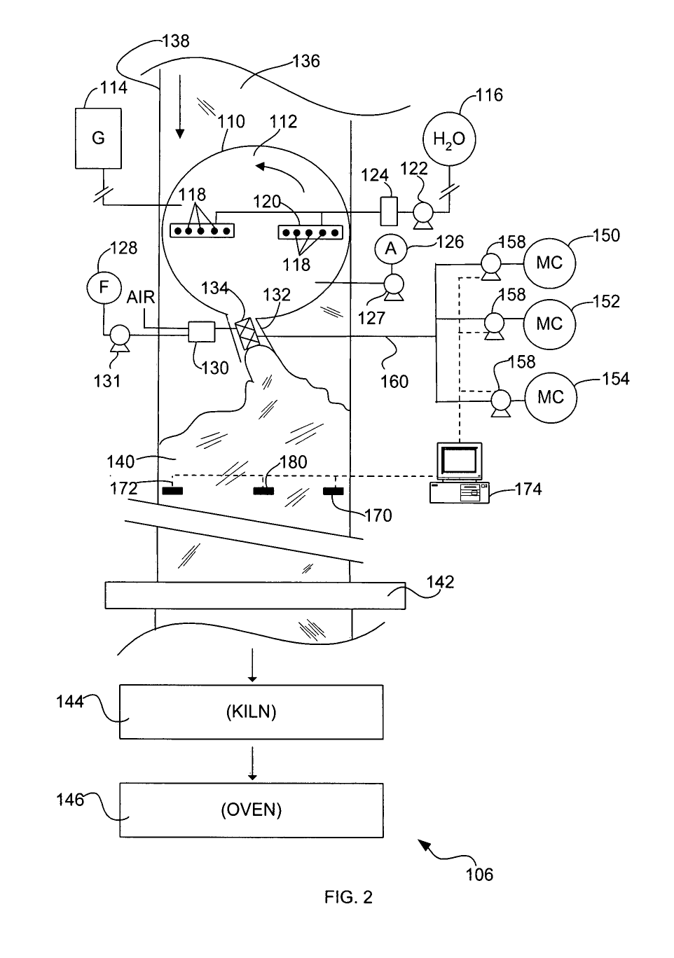

It will be appreciated that the systems 6 and 6′ illustrated in FIGS. 1A and 1B (as well as the methods likewise illustrated) are only some example embodiments of the invention, and that many alternatives and equivalents to the system 6 and its various components are contemplated. FIG. 2, for example, schematically illustrates a second example system 106 for continuously making gypsum wallboard. Because the system 106 is similar in many respects to the system 6, like element numbers in the 100 series have been used to identify elements of the system 106 that correspond to elements discussed above with regard to system 6.

Description of these like elements of system 206 is not provided herein for the sake of brevity, and description may instead be had through the above discussion. By way of example, the rotating pin mixer 110 of FIG. 2 may be considered to be substantially identical to the pin mixer 10 of FIG. 1. Some elements of the example system 106, however, are different from corresponding elements of the example system 6 and will be discussed herein.

For example, the example system 106 is configured to deliver the cellulose ether from one or more of the cellulose ether supplies 150-154 to the slurry mixer through the discharge conduit 132 as opposed to the mixing chamber 12 of FIG. 1. In particular, the cellulose ether delivery pipeline 160 delivers the cellulose ether to the static mixer 134 in the discharge 132 at a location downstream of the location of the introduction of the foam from the foam mixing chamber 130.

The configuration of the example system 106 of FIG. 2 may provide advantages and benefits over the system 6 of FIG. 1 in some (but not necessarily all) applications. Introduction of the cellulose ether to the slurry mixing chamber 112 can increase viscosity of the slurry therein. In some applications, depending on factors such as the type of dry calcined gypsum being used, additives being used, the cellulose ether being delivered to the mixing chamber 112, and others, the quantity and viscosity of the slurry in the chamber 112 can reach a level that causes difficulty in effective mixing. In circumstances such as this, introducing the cellulose ether downstream of the mixing chamber 112 in the discharge conduit 132 allows for the slurry to be effectively mixed prior to addition of the thickening cellulose ether.

Cellulose ether may also function as a surfactant, and in some circumstances has the potential to undesirably interact with the foam. There is the potential, for example, that the cellulose ether may undesirably limit the quantity, distribution and/or size of gaseous bubbles in the slurry. It is believed, however, that introducing cellulose ether at a location in the discharge 132 downstream from location of foam introduction avoids, or at least minimizes, these undesirable effects.

Introduction of the cellulose ether downstream from the foam allows for the foam bubbles to have substantially formed and to have been distributed in the slurry. The cellulose ether can be delivered into the static mixer 134 (at a location downstream of the foam introduction) to ensure good distribution in the slurry. Alternatively, a second static mixer (not illustrated) in the discharge conduit 132 downstream of the first mixer 134 can be provided for mixing the cellulose ether into the slurry.

In addition to use of the static mixer 134, the cellulose ether may be effectively mixed into the slurry in other steps. For example, an additional one or more nozzles such as nozzles 118 can be provided in the discharge 132 or immediately adjacent to the exit to distribute the cellulose ether in the slurry. Other mixing methods are likewise contemplated and will be apparent to those knowledgeable in the art.

The example system 106 includes other alternatives over the example system 10 of FIG. 1. For example, the two sensors 70-72 of FIG. 1 have been replaced with three sensors 170, 172 and 180. The three sensors 170, 172 and 180 are distributed substantially evenly across the width of the conveyor 138. Each may be configured to measure the viscosity of the slurry 140, with the result that a reliable average viscosity is obtained for the overall slurry 140. Alternatively, one sensor 170, 172 or 180 may measure one physical property (e.g., temperature, pH, or foam content), and one or more of the others measure a second (e.g., viscosity).

It will be appreciated that the example system 106 operates in a like manner as the system 6 of FIG. 1. In particular, measurements from the sensors 170, 172 and 180 are monitored by the controller 174, which in turn control the metering pumps 158 to manipulate the delivery of differing amounts and compositions of cellulose ether to the slurry mixer 112. In this manner a dynamic control of the viscosity of the slurry 140 can be achieved in much the same way as was detailed for the system 6 of FIG. 1.

### THIRD EXAMPLE SYSTEM

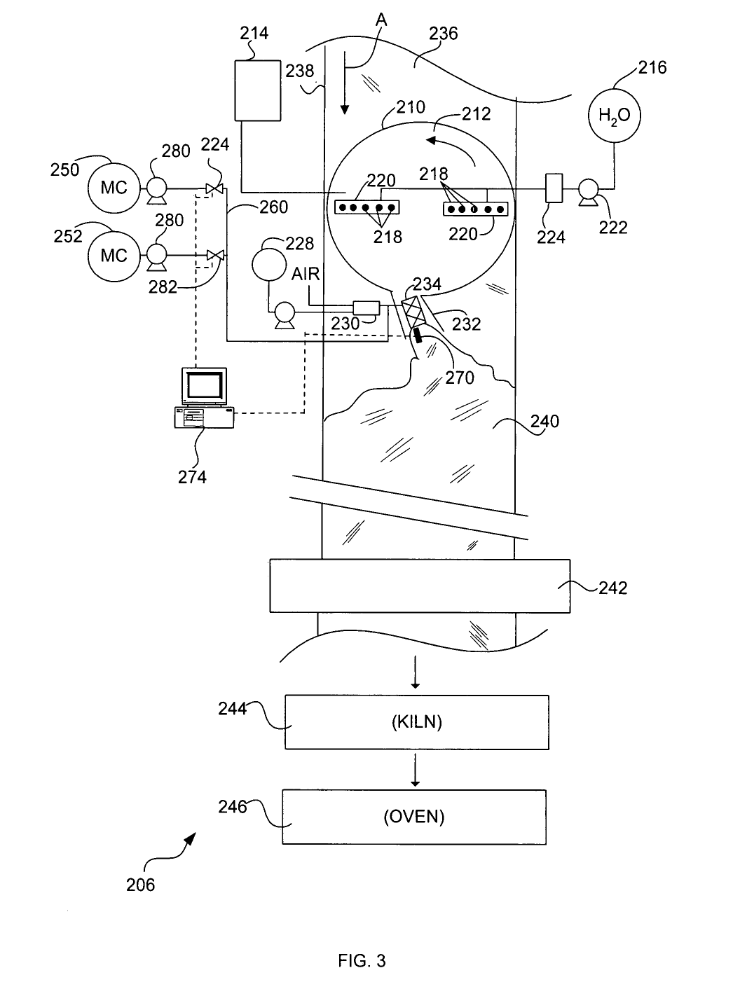

FIG. 3 schematically illustrates a third example system 206 for making gypsum wallboard. Like the second example system 106, the third example system 206 shares many elements with the first example system 6. Accordingly, like element numbers have been used in the 200 series. By way of example, the conveyer 238 of FIG. 3 may be considered to be substantially identical to the conveyer 138 of FIG. 2 and 38 of FIG. 1. Description of these elements is provided through the discussion above of the systems 6 and/or 106. Some elements of the example system 206, however, are different from corresponding elements of the previously described example systems 6 and 106 and are described below.

The example system 206 includes only two cellulose ether supplies 250 and 252. In many applications, two supplies 250 and 252 may be suitable to obtain beneficial results. The two supplies 250 and 252 may include, for example, a “high” MW and viscosity cellulose ether (with an example being cellulose ether having a MW of at least about 200,000) and a “low” MW and viscosity cellulose ether (with an example being cellulose ether having a MW of no more than about 100,000).

The example system 206 using two cellulose ether supplies 250 and 252 can provide reduced cost and simpler operation over an example system that uses three or more cellulose ether supplies. Accordingly, two supplies 250 and 252 may provide advantages that make such a configuration preferred for many, but not all, applications. Some applications may call for a greater ability to “fine tune” the viscosity of the slurry 240, however. For these applications, three or more supplies may be preferable.

The example system 206 is also configured to deliver the cellulose ether through the pipeline 260 to the slurry mixer 210 at a different location than is the example systems 6 and 106. In particular, the pipeline 260 communicates with the foam supply at a location downstream of the foam mixing chamber 230 and upstream of the mixer discharge conduit 232. This can be advantageous in some applications.

For example, delivering the cellulose ether downstream of the mixing chamber 212 avoids increasing the viscosity of the gypsum slurry during initial mixing. Also, adding the cellulose ether to the foam downstream of the foam mixing chamber 230 allows for the foam bubbles to be formed prior to addition of the cellulose ether surfactant, thereby minimizing risks that the cellulose ether will interfere with the foam. The cellulose ether is added to the foam upstream of the static mixer 234 to ensure good distribution within the slurry 240.

It is noted, however, that in some applications interactions between the cellulose ether and foam may occur. These interactions can depend on factors such as the type of surfactant used to form the foam, the size of the foam bubbles, and the like. While in some applications of the invention these interactions have the potential of being disadvantageous, in others it may be possible to exploit these interactions for benefit. It is contemplated, for instance, that the cellulose ether could be used to increase the stability of the foam or to reduce the amount of foam surfactant that was required by supply 228. Accordingly, some systems and methods of the invention may include delivery of the cellulose ether from the supplies 250 and 252 to the foam mixing chamber 230 or to the foam liquid supply 228.

The example system 206 also has replaced the metering pumps 58 of FIG. 1 (and 158 of FIG. 2) with a combination of pumps 280 and valves 282, which can be, for example, control valves. The valves 282 may be linked to the controller 274 for operation to control the quantity of cellulose ether delivered from each of the supplies 250 and 252. The pumps 280 may likewise be linked to the controller 274, or may alternatively be activated whenever the valves 282 are opened, when a driving pressure in supply 250/252 falls below a specified level, or the like.

In the example system 206, only a single sensor 270 has been provided, and has been located in an alternate position as compared to the sensors 70 and 72 (of FIG. 1) and 170 and 172 (FIG. 2). In particular, the sensor 270 has been located within the discharge conduit 232. The sensor 270 may be configured to measure viscosity, temperature, and/or other property of the slurry 240. The sensor 270 may take advantage of a flow bypass from or within the discharge conduit 232 to measure viscosity.

### FOURTH EXAMPLE SYSTEM

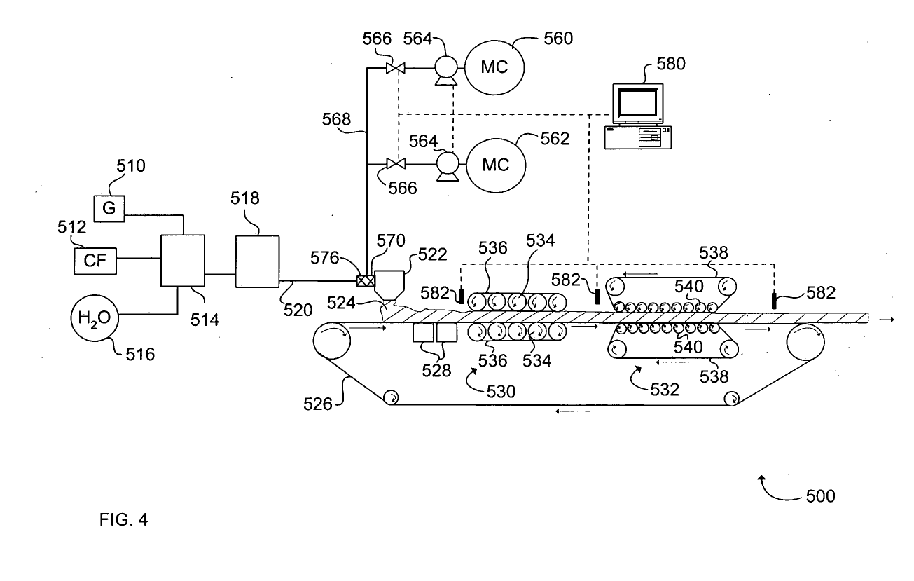

FIG. 4 is a schematic useful to illustrate an example system and method of the invention for making a gypsum fiberboard product. The system 500 includes a gypsum supply 510 which contains solid gypsum in its dihydrate form and a cellulosic fiber supply 512 containing wood pulp, paper pulp, or other fiber material. The supplies 510 and 512 communicate with a slurry mixer 514. A water supply 516 is likewise in communication with the mixer 514.

The supplies 510 and 512 may communicate with the slurry mixer 514 via one or more augers, conveyors, pipes, or other devices useful to carry solids. One or more metering devices, with an example being a scale and a positive displacement metering pump, may be provided (not illustrated) to control the quantity of gypsum and cellulosic fiber supplied to the mixer 514. A metering valve or pump (not illustrated) may likewise be provided to control the quantity of water supplied from supply 516 to the mixer 514. The mixer 514 is configured to mix the gypsum dihydrate, the cellulosic fiber, and the water into a slurry. It can include agitation means, and may by way of example be an agitated slurry tank.

The mixer 514 communicates with a reactor or calciner 518, which is configured to heat the slurry under pressure to elevated temperatures to cause the gypsum to go into solution, recrystallize out, and to form crystals of alpha hemihydrate. By way of example, the calciner 518 may be configured to heat the slurry to a temperature of about 290° F. (143° C.) under sufficient pressure to keep the water in liquid form. Other temperatures may also be useful. When heated to these temperatures, the gypsum dihydrate is calcined and forms gypsum hemihydrate crystals. At least a portion of the crystals form on the cellulosic fiber materials, including in surface imperfections such as cavities, crevices, and the like.

The heated slurry exits the calciner 518 through a conduit 520, which may comprise a pipe, channel, blow tank or the like. The conduit 520 is at or near atmospheric pressure, causing the slurry to quickly cool to about 212°-215° F. as a small portion of the water component boils off. The slurry is delivered to a container such as the head box 522 or an intermediate surge tank or blow tank prior (not illustrated) to the headbox 522. The slurry, which has been identified as element 524 downstream from the head box 522, is deposited by the head box through a lower conduit onto a moving receiver or conveyor 526 (sometimes referred to as forming wire) on a forming table. The head box 522 is generally configured to aid uniform spreading of the slurry 524 across the width of the conveyor 526, and may be generally configured as an elongated (across the width of the conveyor 526) trough, with an example presented in U.S. Pat. No. 6,605,186 incorporated by reference herein.

The conveyor 526 carries the slurry over one or more vacuum boxes 528, a first press shown generally at 530 and subsequently into a second press shown generally at 532. When deposited on the conveyor 526, the slurry 524 is typically at least about 70% liquid by weight. The conveyor 526 is permeable to water. The vacuum boxes 528 are useful to dewater the slurry 524 by suctioning water from it through the permeable conveyor 526, with the slurry 524 taking on the consistency of a moist cake or mat downstream of the boxes 528. In some applications the slurry 524 may have a water content of about 28-42% (wet basis; 40-70% on a dry basis) just downstream from the vacuum boxes 528.

The first press 530 (which may be referred to as the primary press or dewatering press) includes pairs of cooperating rollers 534. A porous belt 536 travels over the respective sets of rollers 534. The rollers 534 cooperate to form a gap there between. One or more of the rollers 534 may be suction rollers, with some applications featuring every other roller 534 being a suction roller. Through compression between the belts 536 and action of the suction rollers 534, the slurry 524 is further dewatered and consolidated in the first press 530. The first press 530 removes most (about 80% or more in some applications) of remaining free water from the slurry 524, and also nips the slurry 524 which now has the consistency of a cake or mat into a desired thickness. Downstream of the first press 530 the slurry 524 in the form of a mat or cake may have a moisture content of, for example, about 23-35% (by weight on a wet basis or about 30-55% on a dry basis).

The second or setting press 532 follows the first press 530. The distance between the two presses (whether measured by distance or time) may be set as desired and can be related to the hydration curve of gypsum hemihydrate. Gypsum hemihydrate curves are well known, with an example presented in U.S. Pat. No. 6,197,235 incorporated by reference herein.

The second press 532 includes a pair of opposing belts 538 each traveling over a set of rollers 540. The belts 538 are generally impermeable to water, and are useful to impart a surface texture or smoothness on the hardening slurry 524. The second press 530 and its belts 538 are also useful to achieve a final calibrated fiberboard thickness as the setting slurry 524 expands therein against the belts 538. Flexural strength is also improved in the second press 532 as the crystallizing slurry (in the form of a mat) expands against the belts 538 as the gypsum rehydrates. The second press 532 often features a nip (defined between opposing rollers 540) slightly thicker than the thinnest nip (defined between opposing rollers 534) of the first press 530 to decrease thickness variation without disrupting the unset mat by extrusion.

Expansion of the crystal formation with the fibrous particles gripped therein forces the setting slurry 524 (which may have the consistency of a mat or cake) against the belts 538 of the second press 532 as the rehydration rate increases to reach a temperature level which is a certain percentage of the difference between the rehydration temperature and the highest temperature achieved during rehydration. At this point the slurry 524, now in the form of a hardened mat, exits the second press 532. Depending on the accelerators, retarders, crystal modifiers, or other additives which may be added to the slurry at the headbox 522 or elsewhere (with examples including starch and other additives discussed herein above with reference to gypsum wallboard examples), hydration may take from only a few minutes to an hour or more in the second press 532.

The slurry 524 cools as it passes through the first and second presses 530 and 532. During this cooling, at least a portion, and in some cases substantially all, of the calcined gypsum hemihydrate that was formed under pressure and heat in the calciner 518 absorbs water from the slurry and converts back to its crystalline dihydrate form. Generally only a small portion of the gypsum hydrates in the first press 530 (about 5-10% in some applications), with the majority of the gypsum hydrating to its dihydrate form in the second press 532. Downstream of the second press 532, the slurry 524 has been converted to a gypsum fiberboard of desired dimensions.

The system 500 may be operated on a continuous or semi-continuous basis. Further drying may be provided of the fiberboard that emerges from the second press 532. Also, the system 500 may include other mechanisms and elements—the illustration of FIG. 4 is schematic only. For example, additional blades, rollers and other devices may be provided to further shape and/or remove water from the slurry downstream from the headbox 522.

As described above, it has been discovered that a gypsum fiberboard product may benefit through inclusion of a cellulose ether, with an example being methyl cellulose. As also described above, however, adding a cellulose ether can be cumbersome. If addition of the cellulose ether causes too great of an increase in the slurry tackiness or viscosity, the quality of the final gypsum fiberboard can be disadvantageously affected. The board may stick, for instance, to one of the belts 536 and/or 538 and thereby suffer surface blemishes or even structural cracks.

These and related problems can be particularly troublesome in fiberboard applications. The temperature of the slurry 524 (which may be in the form of a mat) can vary considerably during its residence in the first and second presses 530 and 532. This is partially a result of, among other factors, a varying degree of vacuum applied through (some or all of) the rollers 540, varying properties of gypsum hemi-hydrate crystals, ambient temperatures, and varying quantity of water present in the slurry. Differing slurry 524 temperatures can affect its response to concentration of cellulose ether.

The system 500 as configured, however, has been discovered to reduce or eliminate such problems. In particular, like the systems 6, 106 and 206, the system 500 is configured to dynamically monitor physical parameters of the slurry 524 and to change the quality and/or quantity of cellulose ether that is added to the slurry at an upstream location. These benefits and advantages are achieved through additional structural elements of the system 500 that are described below.

The system 500 includes at least first and second cellulose ether supplies 560 and 562. Each supply contains a cellulose ether, with an example being methyl cellulose, having different physical or chemical properties. These may include, for example, different MW, DP, DS, and/or chain length cellulose ethers. Also, in some example embodiments, the different cellulose ethers may have different solubility properties—one may be soluble at higher temperatures than the other. Additionally, the materials in each of the supplies 560 and 562 can be different cellulose ethers. For example, supply 560 may contain a methyl cellulose having a viscosity of between about 1,500-15,000 cps, and the supply 562 a HPMC having a viscosity of between about 10,000-50,000 cps. In another example, one supply 560 contains A4C methyl cellulose from DOW CHEMICAL, Midland Mich., which has a generally low viscosity build; and the other supply 562 contains CULMINAL HPMC 1034 methyl hydroxypropyl cellulose from HERCULES AQUALON, Wilmington Del., that has higher strength but also higher viscosity.

The cellulose ethers in the supplies 560 and 562 may be solid or liquid, but are contemplated as being liquid in the example system 500. For example, they may be slurries of cellulose ether in water. As an alternative to the supplies 560 and 562, slurries may be formed through mixing of cellulose ether with water—the supplies 560 and 562 have been illustrated for convenience, and are intended to be representative of many different possible supply configurations. The supplies may be maintained or heated to temperatures of at least about 150° F. (66° C.), and alternatively at temperatures of at least about 160° F. (71° C.), or at least about 180° F. (82° C.). These temperatures are useful to prevent the cellulose ethers from the supplies 560 and 562 from gelling or otherwise dissolving to form a viscous solution.

A pump 564 (which may be a metering pump) is provided in line with each of the supplies 560 and 562, as is a metering valve 566 configured to control the quantity of cellulose ether supplied. Each supply 560 and 562 communicates by a common conduit 568, which may be a pipeline, with an inlet 570 to the headbox 522. If the supplies 560 and 562 contain solid cellulose ethers, the pumps 564 and metering valve 566 may be replaced with augers, conveyors, scales and other devices useful to transfer and measure solids.

A static mixer 576 or other suitable mixing device is provided at the headbox inlet 570 for thoroughly mixing the slurry from the conduit 520 with the cellulose ether fluid stream from the conduit 568. In some invention embodiments, the static mixer could be replaced with a mixer and mixing element, with an example being a small pot mixer with a rotating mixing element. Downstream of the static mixer 576, the headbox 522 will contain a substantially homogeneous mixture of the gypsum slurry and the cellulose ether from one or more of supply 560 and/or 562. In some applications, it is believed that a range of about 0.3-2% by weight cellulose ether on a dry weight basis of calcined gypsum is useful.

The system 500 further includes a controller 580 linked to sensors 582 positioned proximate to the slurry 524 and downstream from the headbox 522 along the conveyor 526. In particular, one sensor 582 is positioned adjacent to and just upstream from each of the first press 530 and 532, with a third sensor placed just downstream of and adjacent to the second press 532. The sensors 582 may be consistent with the sensors 70-72 described above, and may be configured to measure one or more physical properties of the slurry 524, with examples including temperature, pH, tackiness, viscosity, and the like. In one example, some or all of the sensors 582 are infrared sensors configured to measure the temperature of the slurry 524. In another, some or all of the sensors 582 are configured to detect sticking of the slurry 524 to the belts 536 and/or 538 through optical or other means.

The sensors 582 are electrically linked to a controller 580 (linkage shown in dashed line in FIG. 4), which may be consistent with controllers such as the controller 74 (FIG. 1A) or other controllers discussed above. Although only one controller 580 is illustrated in FIG. 5, other numbers may be provided. The controller 580 may be a processor based device such as a computer, and may include a memory with one or more software programs for operating each of the sensors 582, and for processing data from the sensors, with examples being temperature and/or viscosity data. The controller 580 may further include a user interface for user control, and may be linked to a network or with other computers for remote control and other remote interactive capabilities.

The controller 580 is additionally electrically linked to each of the cellulose ether metering valves 566, to the metering pumps 564 and is configured to control the amount of cellulose ether delivered from each of the supplies 560 and 562. In this manner, like the systems 6, 106 and 206 discussed above, the example system 500 can provide beneficial real-time feedback and control of the addition of cellulose ether, and can dynamically vary the amount and/or composition of the cellulose ether added to react to changing properties of the slurry 524. Properties such as the viscosity and tackiness of the deposited slurry 524 can thereby be maintained in a desired range without the need for stopping the continuous manufacture process, even in the face of changing process parameters such as ambient temperature, different additives, or the like.

It has been discovered that useful physical parameter to measure in the slurry 524 in the practice of the example system 500 is temperature of the slurry 524. One exemplary location to measure slurry 524 temperature is downstream from the first press 530 and upstream of the second press 532 (where the slurry 524 may be in the form of a cake or mat). One of the sensors 582 is configured to provide this measurement data. It has been discovered that when adding a cellulose ether such as methyl cellulose to the slurry 524, in many (but not all) applications it is desirable to have the methyl cellulose gel or otherwise dissolve to form a viscous solution in the second press 532 as opposed to the first press 530. Slurry 524 temperature can be a useful indicator of whether (and therefore where) gelling is taking place.

Having the cellulose ether gel in the first press 530 risks undesirable increases in viscosity that may inhibit equal consolidation of the slurry 524 over the conveyor 526, risks blocking water flow out of the slurry 524, and sticking of the slurry 524 to the belt 536. The first press 530 desirably consolidates the existing geometry in slurry 524 thickness as the corresponding pore space is generated by the vacuum removal of water. It preferably should not disrupt the formation of the mat that occurred upstream of the first press 530. Such disruption will can in microfractures in the slurry mat and subsequently lower strength in the final board product. Causing the cellulose ether to gel in (or downstream from) the second press 532, after the majority of excess water has been removed from the slurry 524 and it has adopted close to its final shape reduces or eliminates many of these disadvantageous effects.

It is noted, however, that the present invention also contemplates causing at least a portion of the cellulose ether to gel in the first press 530. Choice of location for gelling will depend, among other factors, on particular process and slurry parameters, as well as the end use application for the gypsum fiberboard.

Referring again to the example system 500, temperature feedback from the sensors 582 can be useful to indicate where the cellulose ether is gelling. For example, most cellulose ethers (although not all) begin to form a gel in aqueous solutions at temperatures below about 150° F. (66° C.), but not above. Accordingly, if the slurry temperature measured at one the sensors 582 is above about 150° F., this is a useful indication that the cellulose ether has not significantly gelled upstream from that location. Similarly, if the temperature at the sensor 582 downstream from the second press 532 is significantly below about 150° F. (66° C.), this indicates that gelling has at least begun in the second press 532.

In this manner the temperature of the slurry 524 at various locations downstream from the headbox 522 can be used to indicate where the cellulose ether gelling is taking place. Other physical parameters of the slurry could also be used, with examples including viscosity, tackiness, pH, sticking to the belts 536 and 538, and the like. It is believed, however, that temperature provides one readily measured and useful parameter.

In the example system 500, the controller 580 is configured to promote gelling in the second press 532 and prevent it in the first press 530 (although some degree of gelling may occur in the first press). It may change the quantity and/or quality of the supplied cellulose ether in response to measurements from the sensors 582. For example, if the temperature at the sensor 582 between the first and second presses 530 and 532 in one application indicated a temperature significantly below about 70° F. (66° C.), the controller 580 could operate one or more of the metering valves 566 or pumps 564 to deliver a cellulose ether supply having a lower viscosity (e.g., lower MW and/or lower chain length) and/or a lesser quantity of cellulose ether to the headbox 522.

Or, in another application, the sensor 582 downstream of and adjacent to the second press 532 may be configured through optical detection or other means to detect that the slurry 524 (which may be in the form of the final hardened fiberboard product) is sticking to the belt 538. Upon detection of such sticking, the controller 580 could manipulate metering valves 566 and/or pumps 564 to deliver less cellulose ether and/or a lower viscosity mixture of cellulose ether to the headbox 522. In this manner the controller 580 promotes gelling in the second press 532 over the first press 530.

In other examples, as slurry 524 temperature increases, the controller 580 may cause more of a cellulose ether with less high temperature solubility, less sticking and better strength to be used (with an example being HERCULES HPMC1034). As the slurry 524 temperature decreases, the controller 580 may cause less of this material to be used and more of a less sticky (i.e., less low temperature solubility) cellulose ether to be used (with an example being DOW MC A4C).

It will be appreciated that the system 500 is schematic only, and has been presented to illustrate some aspects of an example embodiment of the invention. Many alternatives, equivalents, and other modifications are contemplated. By way of example, although only two cellulose ether supplies 560 and 562 have been illustrated, other numbers are contemplated with examples being three or four. The cellulose ether has been illustrated as being delivered to the headbox 522, but it could likewise be delivered at other locations, with examples including an intermediate surge tank or blow tank. Some alternative systems may have alternate presses 530 and 532, and some may use only a single press (e.g., a different density fiberboard product might be made using only the press 530). Many other modifications will be apparent to those knowledgeable in the art. It will further be understood that many of the elements of the systems 6, 106, and 206 for use with wallboard will likewise be useful with fiberboard methods and systems, and vice versa.

As discussed above, it will likewise be understood that the present invention is not limited to systems, but also includes methods for preparing gypsum slurries and gypsum wallboard products. Further, it will be appreciated that methods of the invention include steps of using systems of the invention, and that discussion of example systems of the invention shown in FIGS. 1-4 is intended to likewise illustrate methods of using those systems.

While particular example embodiments of methods and systems of the invention have been provided, it will be appreciated by those skilled in the art that changes and modifications may be made thereto without departing from the invention in its broader aspects and as set forth in the following claims.

What is claimed is:

1. A system for making a gypsum board product comprising:
a container containing a gypsum slurry;
a moving receiver receiving gypsum slurry deposited from said container;
a first cellulose ether supply containing a first cellulose ether communicating with said container;
at least a second cellulose ether supply communicating with said container and containing a second cellulose ether having different physical or chemical properties than said first cellulose ether; and,
a controller configured to change the amount of said first and second cellulose ethers delivered to said container in response to a change in at least one slurry physical property.

2. A system for making a gypsum slurry as defined by claim 1 and further comprising at least one sensor located downstream from said container for measuring said at least one physical property of said slurry.

3. A system for making a gypsum board product as defined by claim 1 and further comprising a water supply configured to combine water at a temperature of at least about 150° F. (66° C.) with said cellulose ether from one or more of said first and at least a second cellulose ether supplies prior to delivery to said container.

4. A system for making a gypsum board product as defined by claim 1 wherein said container further comprises a discharge conduit, and further including a foam supply configured to deliver a foam to said slurry in said discharge conduit at a first location, and wherein said first and at least a second cellulose ethers are delivered to said container at a second location downstream from said first location.

5. A system for making a gypsum board product as defined by claim 1 wherein said container further includes a discharge conduit, wherein the system further comprises a foam mixing chamber for forming a foam communicating with said discharge conduit, said foam delivered to said slurry mixer within said discharge conduit, and wherein said first and second cellulose ether supplies communicate with said container at a location downstream from said foam mixing chamber and upstream of said discharge conduit.

6. A system for making a gypsum board product as defined by claim 1 wherein said container comprises a slurry mixer configured to mix water and dry calcined gypsum to form said slurry, further including a water supply configured to deliver water to said mixer, and wherein said first and at least a second cellulose ether supplies communicate with said water supply whereby said first and at least a second cellulose ethers are delivered to said slurry mixer together with at least a portion of said water.

7. A system for making a gypsum board product as defined by claim 6 wherein said slurry mixer further comprise a mixing chamber and a plurality of nozzles for injecting said water into said mixing chamber, and wherein said first and second cellulose ether supplies communicate with a portion but not all of said plurality of nozzles whereby said first and at least a second cellulose ethers are deposited into said mixing chamber together with a portion of said water.

8. A system for making a gypsum board product as defined by claim 6 and wherein said moving receiver comprises a conveyer carrying a wallboard facing sheet, said slurry mixer configured to continuously deposit said slurry on said wallboard facing sheet, and further comprising a station downstream from said slurry mixer for continuously depositing a second wallboard facing sheet on top of said slurry whereby said slurry is sandwiched between said first and second wallboard facing sheets, and further comprising at least one sensor located upstream from said second station configured to measure said at least one slurry physical property.

9. A system for making a gypsum board product as defined by claim 8 wherein said at least one sensor comprises a manually operated sensor for measuring viscosity of said slurry.

10. A system for making a gypsum board product as defined by claim 1 wherein said at least one slurry physical property is useful to determine slurry viscosity, wherein said second cellulose ether has a higher viscosity than said first cellulose ether, and wherein said controller is configured to vary the quantity and quantity of said first and at least a second cellulose ethers to maintain the relation:
Viscosity_{MIN}≦Viscosity_{slurry}≦Viscosity_{MAX}
where Viscosity_{MIN} comprises a minimum slurry viscosity and Viscosity_{MAX} comprises a maximum slurry viscosity.

11. A system for making a gypsum board product as defined by claim 1 wherein said container comprises a headbox having an inlet through which said slurry is delivered to said headbox, wherein said first and at least a second cellulose ethers are delivered to said headbox at said headbox inlet, and further comprising a static mixer within said inlet configured to mix said slurry with said first and at least a second cellulose ethers.

12. A system for making a gypsum board product as defined by claim 1 and further comprising first and second presses downstream from said container, said moving receiver carrying said slurry through said first and second presses, and further comprising at least one sensor located proximate to an end of said first press and an entrance to said second press configured to measure temperature of said slurry.

13. A systems for making a gypsum board product as defined by claim 1 wherein said moving receiver comprises a conveyor configured to carry said slurry through first and second presses, and wherein said controller is configured to promote gelling of said cellulose ether in said second press and to prevent gelling of said cellulose ether in said first press.

14. A system for making a gypsum board product as defined by claim 1 and further comprising a plurality of sensors located along said moving receiver and are configured to measure said at least one physical property while said slurry is carried on said moving receiver, said plurality of sensors linked to said controller, wherein the system further comprises a water supply in communication with said first and at least a second cellulose ethers wherein said first and second cellulose ethers are delivered to said container together with water from said water supply, and wherein the system further comprises:
a first measuring device communicating with said first cellulose ether supply, linked to said controller, and configured to deliver a specified amount of said first cellulose ether to said container in response to a signal from said controller;
a second measuring device communicating with said at least a second cellulose ether supply, linked to said controller and configured to deliver a specified amount of said second cellulose ether to said container in response to a signal from said controller; and,
a third measuring device communicating with said water supply, linked to said controller and configured to deliver a specified amount of water in response to a signal from said controller.

15. A system for making a gypsum board product as defined by claim 1 wherein said first and second cellulose ethers are solid, and wherein the system further comprises a water supply in communication with said first and at least a second cellulose ethers and configured to supply water at a temperature of at least of 160° F. (71° C.) wherein said first and at least a second cellulose ethers are delivered to said container together with water at a temperature of at least about 160° F. (71° C.).

16. A system for making a gypsum board product as defined by claim 1 wherein said first cellulose ether has a viscosity of between about 1,500-15,000 cps and said second cellulose ether has a viscosity of no more than about 10,000-50,000.

17. A system for making a gypsum board product as defined by claim 1 wherein each of said first and second cellulose ethers comprise one or more of ethyl celluloses, propyl celluloses, hydroxypropyl cellulose, and methyl celluloses.

18. A system for making a gypsum fiberboard product comprising:
a reactor configured to heat a slurry containing gypsum dihydrate, cellulosic fiber, and water to a temperature sufficient to cause said gypsum dihydrate to its gypsum hemihydrate form;
a headbox communicating with said reactor through an inlet;
a dewatering press configured to receive said slurry from said headbox and to remove water therefrom;
a setting press downstream from said dewatering press and configured to receive said slurry from said dewatering press;
at least two cellulose ether supplies communicating with said headbox inlet, each of said supplies containing a different cellulose ether;
at least one sensor located downstream from said headbox and configured to measure a physical property of said slurry; and,
a controller linked to said at least two cellulose ether supplies and to said at least one sensor, said controller configured to use data from said at least one sensor to control the quantity of said cellulose ethers from said at least two cellulose ether supplies and to thereby promote gelling of said cellulose ether in said slurry while said slurry is in said setting press.

19. A system for making a gypsum wallboard product comprising:
a moving conveyor carrying a first substantially continuous wallboard facing material;
a slurry mixer configured to mix water and dry calcined gypsum to form a gypsum slurry in a continuous process, said slurry mixer having a discharge conduit for continuously depositing said slurry on said first wallboard facing material;
a station for laying a second substantially continuous wallboard facing material over said slurry on said conveyor whereby said slurry is sandwiched between said first and second wallboard facing materials;
a first cellulose ether supply containing a first cellulose ether communicating with said slurry mixer, a first metering device between said first cellulose ether supply and said slurry mixer and in line with said first cellulose ether supply;
at least a second cellulose ether supply containing a second cellulose ether that has a different viscosity than said first cellulose ether, said second cellulose ether supply communicating with said slurry mixer, a second metering device between said second cellulose ether supply and said slurry mixer and in line with said second cellulose ether supply;
at least one sensor adjacent to said slurry downstream from said slurry mixer and upstream from said station and configured to measure a physical property of said slurry;
a controller linked to said at least one sensor, to said first metering device, and to said second metering device, said controller configured to receive data from said at least one sensor, and to operate said first and second metering devices; and, wherein said controller is configured to continuously maintain said slurry viscosity between maximum and minimum slurry viscosity limits by operating said first and second metering devices to change amounts of said first and second cellulose ethers being delivered to said slurry mixer in response to changes measured by said at least one sensor.

20. A system for making a gypsum wallboard product as defined by claim 19 and further comprising a foam supply supplying foam to said slurry, and wherein said at least one sensor is configured to measure one or more of pH, temperature, and foam content.
